(19) United States
(12) Patent Application Publication
(10) Pub. No.: US 2008/0046823 A1
(43) Pub. Date: Feb. 21, 2008

(54) Web-based sales transaction interface tool with dynamic personal branding and method of use

(76) Inventor: Scott Anson Korbin, Cary, NC (US)

Correspondence Address: TRIANGLE PATENTS, P.L.L.C., P.O. BOX 28539, RALEIGH, NC, 27611-8539, US

(21) Appl. No.: 11/504,548

(22) Filed: Aug. 15, 2006

(51) Int. Cl. G06F 3/00

(52) U.S. Cl. 715/733

(57) ABSTRACT

Systems and methods for providing real-time collaboration including a customized, personal branded graphic user interface (GUI) having a customizeable palette or console focused around the personal branding of a main user, wherein the main user is interfacing with a second user via remote computers on a network in real-time.

### BACKGROUND OF THE INVENTION

(1) Field of the Invention

The present invention relates generally to web-based, one-on-one contact between two or more parties from a remote distance for the purposes of communication. More particularly, the present invention provides for multiple party sale transaction negotiations, such as between a home buyer, real estate agent and loan officer.

(2) Description of the Prior Art

Loan application software of the prior art does not directly offer conferencing products and/or services, but does offer a platform for managing aspects of the loan process, including marketing, prequalification, origination, automated underwriting, processing, and closing. Such prior art software includes a web based interface for collecting loan application information from a prospect. Other prior art for specific applications include:

### Real-Time Offering of a Financial Product

U.S. patent application Pub. No. 2002/0147669 published Oct. 10, 2002, for Taylor et al. for System and method for offering a financial product.

U.S. Pat. No. 5,867,494 issued Feb. 2, 1999, to Krishnaswamy et al., for System, method and article of manufacture with integrated video conferencing billing in a communication system architecture.

U.S. patent application Pub. No. 2003/0023548 published Jan. 30, 2003, for Duran, for Escrow accommodation system.

### Loan Information Exchange Systems

U.S. patent application Pub. No. 2003/0163408 published Aug. 28, 2003, for Polston et al., for Computerized system and method for exchanging information between a buyer, seller, and lender.

U.S. patent application Pub. No. 2003/0208412 published Nov. 6, 2003, for Hillestad et al., for Method and system facilitating transactions between consumers and service providers.

### Community Service System

U.S. patent application Pub. No. 2004/0103040 published May 27, 2004, for Ronaghi et al., for System, method and computer program product for a law community service system.

### Transferring Control of Internet Conference or Collaborative Session

U.S. Pat. No. 6,668,273 issued Dec. 23, 2003, to Rust, for System and method for application viewing through collaborative web browsing session

### Transmission Rate Detection, Synchronization, and Optimization

U.S. patent application Pub. No. 2004/0103150 published May 27, 2004, for Ogdon et al., for Method and system for providing a presentation on a network

U.S. patent application Pub. No. 2002/0191612 published for Curtis, Dec. 19, 2002, for Method and apparatus for automatically determining an appropriate transmission method in a network

U.S. patent application Pub. No. 2002/0065926 published May 20, 2002, for Hackney et al., for Method and system for synchronizing and serving multimedia in a distributed network

U.S. Pat. No. 6,621,834 issued Sep. 16, 2003, to Scherpbier et al, for System and method for voice transmission over network protocols

U.S. Pat. No. 6,343,313 issued Jan. 29, 2002, to Salesky et al., for

### Computer Conferencing System with Real-Time Multipoint, Multi-Speed, Multi-Stream Scalability

U.S. Pat. No. 6,237,025 issued May 22, 2001, to Ludwig et al, for Multimedia collaboration system.

Prior art systems and methods provide only for static branding or selling graphic user interfaces (GUIs) that do not permit dynamic personal branding, which is important for sales, negotiations, meetings and other transactions where personal relationships can affect the outcome. Thus there remains a need for such dynamic personally branded GUIs wherein a sales user can control a meeting and present information as well as ensure that all communications are personally branded and related to that user in the mind of the viewing user.

### DETAILED DESCRIPTION OF PREFERRED EMBODIMENTS OF THE INVENTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms. Referring now to the preferred embodiments, the design examples are illustrations and are for the purpose of describing a preferred embodiment of the invention and are not intended to limit the invention thereto.

The present invention provides for multiple party sale transaction negotiations, in particular where the interaction is personal and/or collaborative, such as between a home buyer, real estate agent and loan officer. In one embodiment of the present invention, a mortgage loan application interface tool, which utilizes real-time web conferencing to lend clarity and confidence to the mortgage process, is provided. Significantly, the present invention provides a network-based, customizable interface, more particularly, a personal branded graphic user interface (GUI) for use during a web meeting and/or sales transaction where personal relationships play a key role in the negotiations, discussions, and possibly in closing the transaction itself. Due to the changing nature of personal relationships and personal expressions, including but not limited to style, appearance, mannerisms, posture, combination of voice and visuals, etc., a personalized user interface is preferably flexible, updateable, and dynamic, as opposed to the static nature of web site GUIs to date, especially because sales and/or negotiations are influenced substantially by the persons involved, and it is critical that parties have the opportunity to consider the non-verbal expressions, cues, and gestures (which can be more than 90% of the communication between individuals) in order to have a complete picture of the status of the transaction at any given time. Thus, the present invention provides a customizable palette or console that is focused around the personal branding of the seller/user/owner of the site and/or transaction. Personal branding includes a signature or other personal identifier, such as an electronic business card viewable at a predetermined position on the GUI, such as viewable at the bottom portion of the viewing device or screen, for branding the user/sales professional in a flexible, updateable manner. Additionally, and importantly, this type of branding is matched with visual images of the user/seller, such as still photo or video, including live streaming video of the seller/user/broadcaster to provide dynamic personal branding in connection with a viewer/buyer's experience during the live web-meeting or meeting. Additionally, and significantly, this dynamic personal branding is enhanced by a customizable screen contiguous to the personalized console.

Other control or functional operation activation means, such as virtual buttons for a user/viewer to indicate a choice or selection of any of the at least one functional operations are provided with the GUI for use with the system and method of the present invention.

Examples of preferred functional operation activation means include virtual buttons for activating desktop sharing, adding participant, ending the meeting or transaction, transferring control to a predetermined or trusted user. For security, one option according to the present invention is to provide for limited transfer of control to one individual who is established as a trusted user, such as a co-employee, supervisor, or manager.

Most importantly, even with shared control, the GUI retains the personal branding of the user/seller or primary controlling user, with an option to include picture/image of the new controller or secondary controlling user, but still personal branding of the user/seller. Preferably, a preloaded image or video is used for the personal branding. Alternatively, a live image, series of still images, or video is generated at or about the start or launch of the GUI by the controlling user and/or viewing user.

Regarding the personal branding of the collaboration and communication tool having a dynamic GUI for network-based meetings, negotiations or other sales transactions, in order to utilize dynamic personal images or video in conjunction with other substantive visual materials being shown and/or shared with the viewer user, the present invention provides for the GUI operability to permit the controlling user to have selective application sharing to optimize bandwidth and therefore functionality of the GUI during the transaction/meeting at any given point.

Regarding the dynamic, personalized GUI and its bandwidth optimization, the images and/or video are optimized in terms of size and resolution, such as by reduction from a full video screen, or by providing all video at the beginning of the meeting, with a complete transfer to application sharing or other software or tools activation after video completion or termination by the controlling user. At that time, the image or video is reduced or eliminated and the functionality control console or palette collapse or hide on command of the controlling user, and may be reintroduced at any point by the controlling user for increased awareness of personal branding by the viewing user(s). Importantly, the personal branding is individual branding, with operation being principally one-way application sharing but providing for relational two-way sharing during the meeting, such as the existence of a predetermined, trust-based relationship that provides a secondary controlling user the authority to share application; at that time, either the primary or secondary controlling user (neither of which are preferably the viewing user(s)) can click select to stop sharing/end sharing, at which time the GUI automatically reintroduces the control palette with user personal branding.

In a preferred embodiment of the present invention for the collaboration and communication tool having dynamic personal branding, the controlling user and/or viewing user is capable of continuing use of other applications. By way of example, the controlling user managing the interface can activate an email invite. Such an emailed invitation to join the meeting or join a later meeting is operable to send only the URL from within the GUI and the start meeting option; this functionality is important to provide a text email that is not an html link, since some network system firewalls do not allow an email including an html link to pass through the system firewall. The emailed invitation function is operable to customize the message to a specific recipient or user, to a team or group of viewing users, or for making an individual introduction, not merely changing the larger message. In an alternative embodiment of the present invention, the controlling user engaged with the system and the GUI with dynamic personal branding according to the present invention has the option to send an email invite with html link and/or text message, if the recipients firewall settings permit its passage on to the intended recipient without modification or omission of the link. The timing of the email invitation may be optionally before and/or during an active meeting or transaction.

A method of using the system set forth hereinabove is also considered within the present invention. Steps included in the method are:

Providing a web-based collaborative selling tool for use as a communication tool/application for a network-based meeting or transaction by a controlling user and at least one viewing user, wherein the viewing user is remotely located from the controlling user; and wherein the system includes a network of computers or computer communicable devices for permitting a controlling user and at least one viewing user to engage in an on-line meeting or transaction wherein each has a viewing device provided by a server running software hosting a website with a dynamic, personally branded GUI;
The controlling user selects from at least one of a multiplicity of function/action selection means viewable on the screen to activate or start the meeting online, with the controlling user's computer and at least one viewing user's computer or computer communicable devices being connected to a network for viewing the site;

### The controlling user selecting and activating the function that provides for personal branding, including activating substantially real-time still image(s) or video alone or in combination with other flexible, updateable static personal branding;

### The controlling user launching one of at least one software or tools, such as a slide-type presentation or template for the meeting;

### The controlling user launching another one of at least one software or tools that are non-integrated but visually apparently integrated software or tools;

### The controlling user completing the presentation, such as by reviewing steps covered and/or next steps;

### The controlling user optionally introducing another individual associated with the transaction, such as an assistant who might follow-up to close the sale or transaction, or provide other customer service, technical, or informational support;

### The controlling user optionally transferring control of the meeting to a trusted user;

### The controlling user or transferred controlling user closing the meeting.

Thus, the present invention provides a system and methods for using dynamically personally branded web-based GUIs that function as either one-on-one selling tools or small group selling tools, such as meetings with between about 5-25 people at remote locations, or a GUI with up to 250 people in a small meeting.

The present invention is operable to permit a controlling user (or their designated assistant/co-user or secondary controlling user) to start or initiate a meeting from any remote computer with Internet access by accessing the web-based system; note that in one embodiment of the present invention, the icons load onto the desktop screen immediately after downloading the software from the User Specific web-site reside on the desktop.

In a preferred embodiment of the present invention, a sustainable and dynamic personal branding console is provided on the GUI that is viewable by the viewing user, wherein the console gives the appearance of integration of a multiplicity of software applications and/or tools and personal branding, even though functionally the system is operable to provide for simultaneous use of diverse and/or different software without actually integrating their packaging or use online. Thus the present invention provides for a simple method for providing a dynamic personally branded GUI for hosting and viewing web-based meetings and/or transactions wherein different software or tools appear to be integrated while retaining independent, simultaneous operation of the same without actually having integrated those tools or software.

In one preferred embodiment, the GUI is designed for a single application or industry setting, in particular, the mortgage industry vertical (mortgage broker target) wherein =end-to-end collaboration and application sharing of tools in the mortgage industry is enabled with the strategic addition of a dynamic, personalized and customizable GUI at the end user level, or viewing user perspective. The dynamic, personalized GUI includes a substantially real-time still image, series of still images, or video as well as a virtual electronic business card placement at a predetermined location on the viewing screen, such as the bottom of the control panel or console. The business card preferably includes a viewable logo, name, address, or other contact information, as well as the personal branding of the sales person (not the company) by inclusion of the substantially real-time images, preferably of the controlling user, which may be a seller in a sales transaction. The controlling user operates and controls all functional aspects of the GUI viewed by the viewing user, including but not limited to the steps of uploading any logo, software, or tool, and, significantly, when another software or tool is in use or activated by the controlling user, the image/picture, series of images, or video dimensions or size is automatically resized and saved so that any time running the software, the uploaded customization is included, while optimizing bandwidth and coordinating with the other software or tools, which are not actually integrated with the web-based meeting GUI, but appear to be to the viewing user. The controlling user may also add links to favorite industry-specific applications, video, presentation, etc., and opens the other program and runs/shares it within the console of the GUI, the controlling user may also click select a button/option within the console, thereby activating any links anywhere within the GUI from any application. Therefore, the methods and processes by which the present invention changes the way people do work in this industry provide for an electronic web-based tool having dynamic personal branding. This permits a new method of doing business within any professional sales industry, by way of example but not limitation, mortgage lending/loan officers, real estate sales/service, legal services, and the like.

### Design Example

By way of example and not limitation, a web-based meeting or transaction using the system and methods of the present invention includes the following steps:

Providing a system including a network of computers or computer communicable devices for permitting a controlling user and at least one viewing user to engage in an on-line meeting or transaction wherein each has a viewing device provided by a server running software hosting a website with a dynamic, personally branded GUI;
The controlling user selects from at least one of a multiplicity of function/action selection means viewable on the screen to activate or start the meeting online, with the controlling user's computer and at least one viewing user's computer or computer communicable devices being connected to a network for viewing the site;

### The controlling user selecting and activating the function that provides for personal branding, including activating substantially real-time still image(s) or video alone or in combination with other flexible, updateable static personal branding;

### The controlling user launching one of at least one software or tools, such as a slide-type presentation or template for the meeting;

In the case of a mortgage transaction, the controlling user shows the viewing user loan options suitable for the transaction and viewing user's background data, such as with Mortgage Coach software; or the controlling user shows the viewing user live bond market data such as with Mortgage Market Guide software to advise on loan lock-in or float options suitable for the transaction and viewing user's background data;
The controlling user launching another one of at least one software or tools, such as a point of sale software, such as with Calyx® Point® or Encompass™, a mortgage market guide, reviewing a credit report, and the viewing users background data, or other non-integrated but visually apparently integrated software or tools;

### The controlling user completing the presentation, such as by reviewing steps covered and/or next steps;

### The controlling user optionally introducing another individual associated with the transaction, such as an assistant who might follow-up to close the sale or transaction, or provide other customer service, technical, or informational support;

### The controlling user optionally transferring control of the meeting to a trusted user;

### The controlling user or transferred controlling user closing the meeting.

Certain modifications and improvements will occur to those skilled in the art upon a reading of the foregoing description. By way of example, the dynamic personally branded web-based GUI for network-based communications, such as meetings, negotiations, or sales transactions may be operable to functionally integrate within the system any disparate software, tools, or other components, although in the preferred embodiment set forth hereinabove, such disparate software, tools, or components function independently and are only visually or virtually integrated, i.e., they appear to be integrated to the controlling user and/or viewing user(s), but actually function separately. Also, other functionality may be operated within the system by the controlling user, such as web co-browsing to redirect or drive client or viewing users outside the console or site while remaining within the active meeting or communication. Also, in another embodiment, the images or video can be multi-way, providing for complete interactivity by all parties. All modifications and improvements have been deleted herein for the sake of conciseness and readability but are properly within the scope of the present invention.

What is claimed is:

1. A system for providing real-time collaboration comprising:
a customized, personal branded graphic user interface (GUI) having a customizeable palette or console focused around the personal branding of a main user, wherein the main user is interfacing with a second user via remote computers on a network in real-time.
